(19) United States
(12) Patent Application Publication
(10) Pub. No.: US 2005/0187868 A1
(43) Pub. Date: Aug. 25, 2005

(54) Method and system for consensual referrals using multimedia description of real estate transaction

(75) Inventors: Paul Christopher Aspelin, Victoria, MN (US); Michelle Lynn Aspelin, Victoria, MN (US)

Correspondence Address: ALTERA LAW GROUP, LLC, 6500 CITY WEST PARKWAY, SUITE 100, MINNEAPOLIS, MN, 55344-7704, US

(73) Assignee: First To Visit, LLC

(21) Appl. No.: 11/054,769

(22) Filed: Feb. 8, 2005

Related U.S. Application Data
(60) Provisional application No. 60/547,610, filed on Feb. 24, 2004.

(51) Int. Cl. G06F 17/60

(52) U.S. Cl. 705/39; 705/40

(57) ABSTRACT

A new property owner is provided with the ability to send to whomever she wishes a link to an announcement about the new property. The announcement is an interactive web document that includes information about the new property owner, a presentation of the real estate, a testimonial about the transaction, an announcement link dissemination facility, and information about or links to information about participants in the real estate transaction, the community, and other subjects related to the transaction and of possible interest to friends, associates, and personal and business acquaintances of the new property owner. Any viewer of the announcement may use the announcement link dissemination facility to send an invitation to other people to view the announcement. As direct and indirect recipients of the announcement view it, they may read the information about the participants and choose to contact the participants, whereupon referrals are generated for the participants.

### CROSS-REFERENCE TO RELATED APPLICATIONS

This patent document claims the benefit of U.S. Provisional Patent Application No. 60/547,610 filed Feb. 24, 2004 (Aspelin, et al., Method and system for consensual referrals using multimedia description of real estate transaction), which hereby is incorporated herein in its entirety by reference thereto.

### BACKGROUND OF THE INVENTION

1. Field of the Invention

The present invention relates to real estate transactions, and more particularly to consensual referrals arising from real estate transactions.

2. Description of the Related Art

FIG. 1 shows a typical real estate transaction 10 through closing. A real estate agent and a buyer establish a relationship (block -20), and for new construction a builder and the buyer also establish a relationship (block 30-YES and block 35). In most transactions a lender and the buyer also establish a relationship (block 40). In due course desirable real estate is found and a purchase contract is entered into (block 50). After pre-closing inspection (block 60) and closing (block 70) takes place, the real estate agent requests referrals (block 80).

The Internet is commonly used to market real estate and the services of various transaction participants, including real estate agents. Many online products are available to assist the real estate agent in soliciting new clients and exhibiting properties that the real estate agent has listed, including slide shows and virtual tours of listed property.

Securing the buyer's testimonial and referrals after a successful real estate transaction is concluded is important to the real estate agent, since testimonials and referrals assist the real estate agent in winning new clients. Unfortunately, securing a well written testimonial and comprehensive lists of referrals can be quite difficult, not only because the buyer may be unfamiliar with preparing and furnishing a testimonial and may feel uncomfortable giving out names of others for the referrals, but also because the real estate agent may fear rejection by the client. Many online products are available to assist the transaction participant in the delicate and difficult task of securing testimonials and referrals. Such products as “By Referral Only” available online at www.byreferralonly.com can teach the transaction participant various techniques for progressively educating the client on the referral process, so as to increase the likelihood of a successful outcome when the real estate agent requests the testimonial and referrals at the conclusion of the real estate transaction.

While marketing training is useful, it has limitations. Even the most sophisticated of clients may not remember or care to spend time furnishing a lengthy list of referrals to the real estate agent, and essentially all clients may have some reluctance giving out email addresses of referrals. Moreover, even if the transaction participant is able to secure email addresses from referrals, spam blockers operated by many Internet service providers and built into many email programs or avail as add-ins may block emails from the real estate agent.

Accordingly, a need exists for a marketing technique to obtain referrals from a buyer without placing an undue burden on the buyer and without placing the buyer in the uncomfortable position of furnishing the email addresses of others to the real estate agent.

### BRIEF SUMMARY OF THE INVENTION

These and other disadvantages are overcome by the present invention which in one of its embodiments is a method of obtaining consensual referrals arising from a transaction involving real estate, at least one party having an relationship to the real estate as a result of the transaction, and at least one party being a participant in the transaction. The method comprises presenting to a first viewer a first invitation to view the announcement, the announcement comprising information on the related party and a presentation on the real estate; furnishing the related party information and the presentation to the first viewer, in response to a request from the first viewer; presenting an option to the first viewer to receive information on the transaction participant; presenting to the first viewer an opportunity to furnishing address information for a second viewer; presenting to a second viewer a second invitation to view the announcement, in response to address information from the first viewer; furnishing the related party information and the presentation to the second viewer, in response to a request from the second viewer; presenting an option to the second viewer to receive information on the transaction participant; and presenting to the second viewer an opportunity to furnishing address information for a third viewer.

A method may comprise the foregoing as well as furnishing a testimonial in response to the first viewer request; and furnishing the testimonial in response to the second viewer request.

A method may comprise any of the foregoing wherein the presentation is a slide show.

Another embodiment of the present invention is a method of generating referrals arising out of a transaction involving real estate, comprising: downloading a web document, the web document comprising embedded or linked information on a buyer/lessee of the real estate, a presentation of the real estate, a testimonial on the real estate transaction, information on a transaction participant involved in the transaction, a capability to receive address information; identifying the buyer/lessee from the buyer/lessee information displayed in the web document; experiencing the real estate presentation in response to recognition of the buyer/lessee from the identifying step; furnishing address information; and initiating generation of email messages addressed in accordance with the address information and containing linking information to the web document.

Yet another embodiment of the present invention is a method of obtaining referrals arising out of a transaction involving real estate, comprising: creating a web document, the web document comprising embedded or linked information on the buyer/lessee of the real estate, a presentation of the real estate, a testimonial on the real estate transaction, information on a transaction participant involved in the transaction, a capability to receive address information; establishing a capability to generate messages addressed in accordance with the address information and containing address information of the web document; posting the web document; and presenting the posted web document to the buyer.

A method may comprise the foregoing as well as obtaining pictures of the real estate for the presentation; and obtaining the testimonial from the buyer.

Yet another embodiment of the present invention is a computer-generated user interface for obtaining referrals arising out of a transaction involving real estate, comprising: a first section comprising information on a person having a relationship to real estate; a second section comprising a presentation of the real estate; a third section comprising a testimonial on the real estate transaction; a fourth section comprising information on a transaction participant involved in the transaction; and a fifth section comprising a capability to receive address information for generating messages addressed in accordance with the address information and containing address information of the web document.

A user interface may comprise the foregoing as well as a sixth section comprising a guest book.

### BRIEF DESCRIPTION OF THE SEVERAL VIEWS OF THE DRAWINGS

FIG. 1 is a flow chart showing a typical prior art real estate transaction through closing.

FIG. 2 is a flow chart showing an improved real estate transaction in which various activities are conducted before, during and after the time of closing to obtain information needed for an announcement about a real estate transaction, and to facilitate the acquisition of a testimonial with respect thereto, in accordance with the present invention.

FIG. 3 is a flow chart showing preparation of an announcement and subsequent use thereof, in accordance with the present invention.

FIGS. 4 and 5 are images of various invitations that may be sent to prospective viewers of an announcement.

FIGS. 6-21 are images of an announcement as it progresses through various views both automatically and by interactive activity of a viewer, in accordance with the present invention.

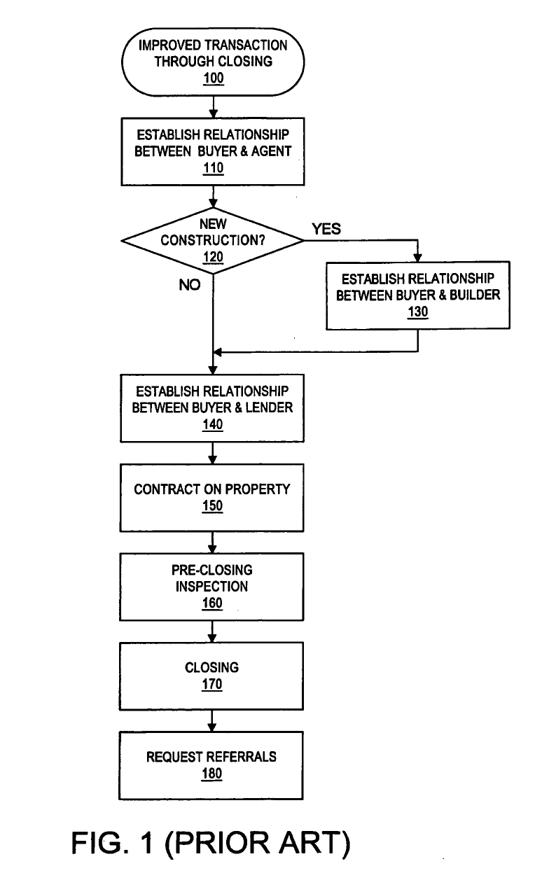

### DETAILED DESCRIPTION OF THE INVENTION, INCLUDING THE BEST MODE

Any participant in a recently completed real estate transaction, including real estate agents, lenders, builders, attorneys, appraisers, inspectors, title companies, and the like, may increase the number of referrals from the transaction by providing persons having a relationship to the real estate as a result of the transaction the ability to send anyone to whom they wish a link to an announcement about the real estate and the transaction. The real estate transaction may be a sale or lease, and the related persons may include the buyer or lessor, the immediate family members of the buyer or lessor of a home, the business associates or tenants of the buyer or lessor of commercial property, other such persons, and any combinations of the foregoing. A “link” is any mechanism for displaying information in a browser window, and includes uniform resource locators (“URL”), hyperlinks to other documents and other portions of one document, path and file names, and so forth. The announcement preferably is an interactive web document that includes information about the related persons, a presentation of the real estate, a testimonial about the transaction, an announcement link dissemination facility, and information about or links to information about the participants in the real estate transaction, the community, and other subjects of relevance to the real estate transaction and of possible interest to friends, associates, and personal and business acquaintances of the new property owner. The announcement and announcement link dissemination facility are integral to a marketing method that recognizes and builds upon two powerful human characteristics, namely: (1) people naturally crave the opportunity to show off their new home; and (2) people instinctively share an email they find entertaining and informative.

The presentation preferably is based on pictures of the real estate, and may include a slide show, a montage, or any other desired display of pictures. The related persons information preferably is displayed continuously during the presentation, and preferably includes one or more pictures of the related persons and a short personalized narrative. Preferably a testimonial is included in the announcement. The testimonial may be part of the presentation preferably displayed at the end, or may be displayed apart from the home presentation but either intermittently or continuously during it. The announcement link dissemination facility is any mechanism for a viewer of the announcement to send an invitation to another person to view the announcement. One example is a section of the web document such as a form for receiving email addresses from the viewer, the addresses being used by the announcement server to generate email invitations to other persons. The same section or if desired a different section of the web document may be used for sending an invitation to the viewer herself, so that the viewer may forward the invitation to contacts in the viewer's personal address book. Information about the participants in the real estate transaction, the community, and other subjects of relevance to the real estate transaction is included in the announcement in any desired manner, such as by incorporating the information into the web document or by incorporating links to the information into the web document when the information is stored on other web sites.

The announcement is hosted under an administrator's account on a single web site or on multiple web sites by a hosting service, and is created and maintained by an administrator. The administrator preferably is the real estate agent, although any transaction participant may be the administrator. Preferably the web document has only a single administrator, although multiple administrators may be allowed if desired. Permissions subservient to administrator may be established if desired, whereby one transaction participant is the administrator who may assign permissions to other transaction participants to access limited specified areas of the web document for limited specified purposes such as updating information. The administrator may also assign permissions to automated update services for updating information without the need for manual involvement.

The hosting service may create an account for the administrator or team of administrators, and charge a hosting fee to the account for making available the announcement server and email server and for furnishing the hosting services. The account may be limited to the hosting of a single announcement or of any desired number of announcements (illustratively, 30 announcements per account) or may be for a period of time. Fees are suitably established based on the hosting arrangement. Examples of suitable fees are $35 for a one-time presentation, and $999 for an unlimited number of presentations over the course of a year. Preferably the account is identified by the name of the administrator, which may be displayed continuously during the presentation if desired. Where multiple administrators are permitted, preferably the administrator's name is locked after it is entered so that the announcement is identified with only a particular one of the administrators. The hosting service may reset the name field so that errors may be corrected or approved changes made.

While the announcement and methods for creating and using it are hereinafter described in the context of a residential home purchase in which the related parties are illustratively the buyers, it will be appreciated that the residential purchase embodiment is only illustrative, and that the following description is also applicable to any real estate transaction, including those involving the sale or lease of a home, the sale, purchase or lease of a business, the sale, purchase or lease of land, a real estate investment, sale, purchase or lease, or indeed any other type of real estate transaction. The following discussion focuses on a residential home purchase for purposes of clarity, since this type of real estate transaction is the most common and is generally understood by many people.

An announcement for a home purchase transaction is created in the following manner. The administrator acquires one or more pictures of the new homeowner (including the new homeowner's immediate family), a number of pictures of the home, and preferably a testimonial from the new homeowner. An owner's section and a home show presentation section are created side by side on a web page, so that both are immediately viewable by the viewer when the web document is opened in a full screen window. The administrator uploads one or more pictures of the new homeowner to the web site, and the new homeowner's picture is displayed in the owner's section preferably as a still picture or, in the event of multiple pictures, a montage of still pictures. Alternatively, slide show depictions or other types of depictions may be used if desired. The administrator also uploads the pictures of the home into the web document to create the new home presentation, and preferably sets the presentation to music. While a flash presentation slide show is preferred, any slide shown or other presentation software may be used. Preferably the home pictures are advanced automatically at intervals using transitions set in the software by the administrator, although controls may be presented to the viewer for manually controlling the presentation (for example, pause, resume, forward, back) to some extent.

While the various areas of the web document preferably are created as different sections of a web page, they may be displayed in any desired manner, including as frames containing other web documents.

The announcement is used in the following manner to obtain consensual referrals. By establishing a new home presentation for the new owner, the administrator reinforces the sense of excitement that the new homeowner has in his or her purchase, and makes an instant and favorable impact. Because of the excitement created, favorably impressed new homeowners happily and eagerly provide email addresses of their friends and family to the announcement server using the announcement link dissemination facility, or send the announcement link directly to their friends and family using their own email program, thereby consensually spreading the word about the administrator's services and the services of the other transaction participants who are included in the announcement. The friends and family in turn catch the excitement, and happily and eagerly provide email addresses of their friends and family to the announcement server using the announcement link dissemination facility, or send the announcement link directly to their friends and family using their own email program, thereby consensually further spreading the word about the administrator's services and the services of the other transaction participants who are included in the announcement. Since the new property owners and their sphere of influence in effect represent an affinity group favorably disposed to the transaction that is the subject of the announcement, the announcement and all of the information contained therein likely will favorably impress the new homeowner's entire sphere of influence. As a result, the new home presentation provides the transaction participants access to the new homeowner's entire sphere of influence, a virtually untapped target market.

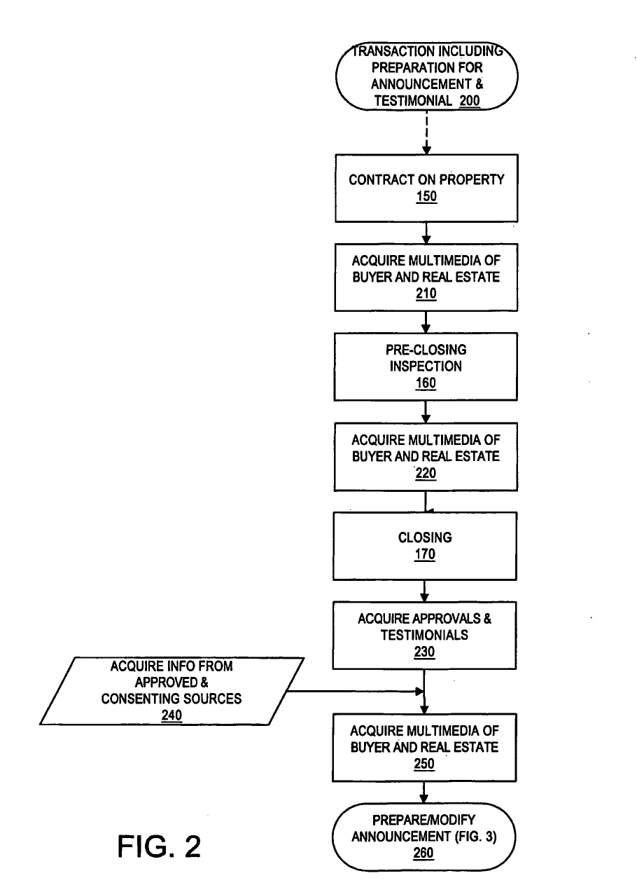

FIG. 2 is a flowchart that shows a modified real estate transaction 200 that includes activities in anticipation of preparation of the announcement and the testimonial. Once a contract on the home has been entered into (block 150), the real estate agent or other transaction participant, or even the prospective new homeowners themselves, may take pictures of the property or of themselves, prepare a written or recorded memorandum of the moment, or acquire any other type of information in anticipation of preparing the announcement (block 210). The time of entering into the contract is a good opportunity to introduce the idea of an announcement to the prospective new homeowner, especially since the contracting phase is a very exciting time for the prospective new homeowner. When describing the announcement, the real estate agent or other transaction participant may wish to mention that the announcement may include a testimonial on the transaction, and provide the prospective new homeowner additional background on the testimonial. In due course the pre-closing inspections are performed (block 160). This is also a good time to acquire additional multimedia (block 220) such as pictures of the home, and especially of difficult subject areas, since the inspections can be quite thorough. Once the closing has occurred (block 170), the testimonial and any desired releases and approvals are obtained from the new homeowners (block 230), additional information and approvals are acquired from others, including information and approvals from other transaction participants as well as other information sources (block 240), and additional multimedia are acquired from the new homeowners (block 250) if desired. Once all pertinent information has been obtained, the announcement is prepared (block 250). If additional multimedia is acquired after the new homeowners move in (block 260), which may be especially appropriate as the home is furnished by the new homeowners, the announcement may be modified (block 260) by the administrator to include the new multimedia.

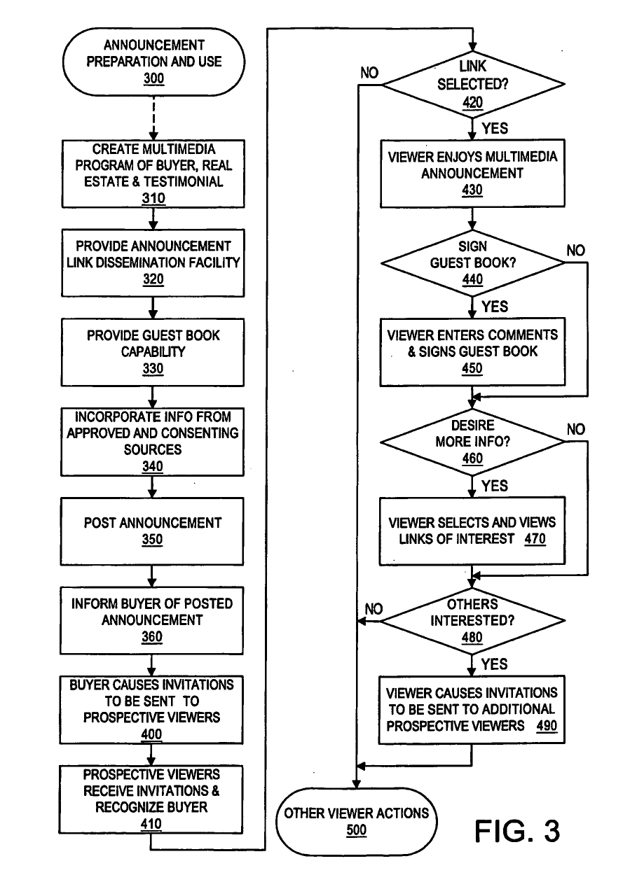

FIG. 3 is a flowchart that shows preparation and use of the announcement. In block 310, a multimedia program is created that includes information about the buyers (or more generally about the related persons), about the real estate involved, and about the transaction experience itself. While the information about the buyers and about the real estate preferably includes pictures and picture captions, more extensive textual information, music and audio voiceovers, and so forth may be used if desired. Illustratively, a Flash slide show home presentation may be created using, for example, twelve new home photos and one photo of the new homeowners to show-off the new home. While this number of home and homeowner's photos is just about right for most situations, it will be appreciated that fewer or more photos of the home and of the homeowners may be used as desired for any particular situation. The homeowner photo or photos and the new home photo or photos may illustrate the new homeowners and the new home prior to the sale, immediately after the sale, after move-in, or any combination thereof. The term “home photos” is inclusive of views of the interior and exterior of the structure, the grounds on which the home sits, and the neighborhood (views from the home, neighboring homes and residents, immediately nearby amenities, and so forth) in which the home is located. The home presentation primarily is a celebration of the new homeowners and their having made an important personal transition of great personal significance to them and to their family and friends.

Preferably the home presentation is accompanied by music, voice narrative, or both, and the color schemes, titles, picture captions, music and other content may be customized by the administrator. The new homeowners may provide a recorded message, and other narration may be provided as well, either to enhance the experience or to assist the visually impaired. The homeowner's message and the narration may vocalize the text shown in the home presentation, or may be in addition to the text.

Information about the transaction experience, including comments on the services of the real estate agent and perhaps other transaction participants involved in the transaction, preferably prepared by the new homeowners as a testimonial. Alternatively, the real estate agent or other transaction participant may prepare all or portions of the transaction experience information, describing from their perspective the new homeowners experience and their role and accomplishments in the transaction. The transaction experience information preferably is automatically displayed at the end of the new home presentation. Alternatively, the transaction experience information may be made manually available at the viewer discretion by a selection button or any other linking technique, or may be displayed continuously along with the new homeowner information. Where the transaction experience information is a testimonial, the testimonial preferably informs the viewer that the new homeowners are a satisfied client of the real estate agent or other transaction participant, thereby serving as an endorsement by which referrals may be generated.

The new homeowner information and the home presentation preferably are displayed together. Additionally, a section that includes a relatively small amount of key information about the administrator may be provided, and may if desired be displayed along with the new homeowner information and the home presentation.

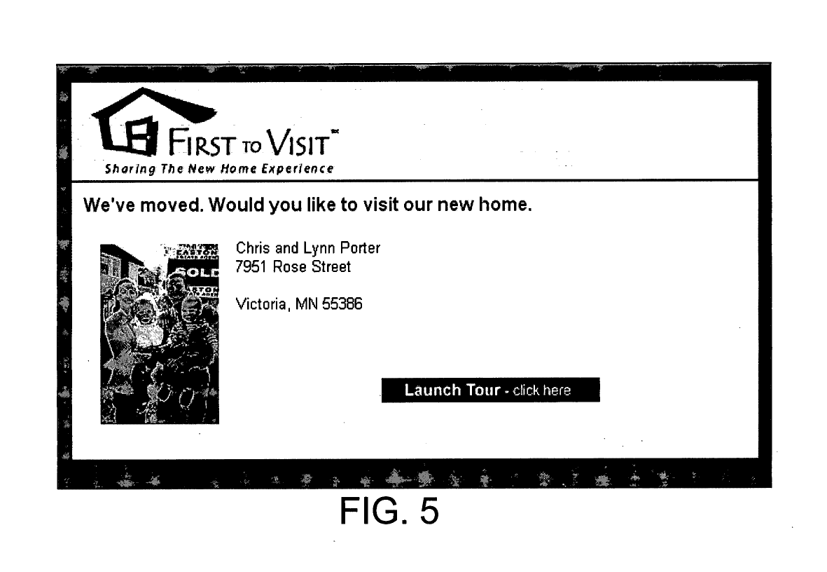

In block 320, an announcement link dissemination facility for sharing the home presentation with others is provided, so that information in the announcement may be disseminated and referrals thereby generated. The announcement link dissemination facility may be implemented in any one or more of a variety of different techniques. In an illustratively email embodiment, a button is provided to “Email A Friend,” since homeowners and their friends will be excited to inform their friends and other acquaintances of the new home purchase. The button causes a form to be displayed by which the viewer may enter the email addresses of others. When the form is closed, an email may be sent from, for example, an email server associated with the server hosting the web document to the various addressees. The email received by the prospective viewers, an example of which is shown in FIG. 5, preferably contains the new homeowner's name in the subject line, an invitation in the body to view the new home presentation, preferably additional information in the body such as a picture of the new homeowners and their names and address, and a control button to link to the announcement. It will be appreciated that this particular approach is merely exemplary, and that other techniques may be used to cause the home presentation to be displayed on a viewer's device. While the viewer's device preferably is a computer, a communications-enabled PDA, a WAP-enabled phone, or a smartphone or other communications appliance having Internet access, the viewer's device may also be a device as simple as a mobile phone that can receive SMS messages, instant messages, or other such messages, or a pager that can receive text messages. In these instances, the viewer may make note of the link and access the web document later, when a device having a suitable browser is available.

In block 330, an interactive guest book capability is provided. The Interactive guest book provides each and every viewer an opportunity to record a message of congratulations for the homeowner. If desired, each message recorded may be forwarded directly to the new homeowner by email. Preferably the guest book is open to each person who views the web document.

In practice, each transaction participant, and especially the real estate agent, should be among the first to sign the guest book. Not only would this be expected, since the transaction participants know the new homeowners from their involvement in the transaction, but being among the first to sign exposes the transaction participant to subsequent viewers of the announcement. Other transaction participants who should sign the guest book include the lender, builder, title company representative, and the attorney.

In block 340, other desirable information from various sources is incorporated into the web document in any desired manner, either by embedding therein or by linking thereto. These sources may or may not require prior approval and consent. The information is made accessible to the viewer preferably by the use of a control such as a button, which preferably is displayed along with the home presentation so that the viewer may select a button to access the information either during or after the home presentation. While virtually any type of information may be provided, particularly desirable types of information includes information about the real estate agent, the lender, the builder (for new home construction), and information about the community, as well as directions to the new home. If a particular type of information is not provided, preferably the button for that type of information is not displayed.

Selecting the “My Real Estate Agent” button causes the display of information about the real estate agent. Suitable information includes the agent's picture and the logo of the agent's company, contact information, sales information, links to the agent's web site, and email address, as well as highlights of the real estate agent's abilities and accomplishments. Preferably the information is customizable. Preferably the real estate agent is the administrator of the web document, and so has full control over the content of the document, including information about the real estate agent.

Selecting the “My Lender” button causes the display of information about the lender, thereby indicating that a team effort was involved to make the real estate transaction a success. Suitable information includes the lender's picture and the logo of the lender's company, contact information, involvement in other transactions, links to the lender's web site, and email address, as well as highlights of the lender's abilities and accomplishments. Preferably the administrator rather than the lender controls the content of the web document, so the lender's information preferably is furnished to the administrator for inclusion in the web document. The lender may be required to pay for this exposure, if desired.

Selecting the “My Builder” button causes the display of information about the builder, thereby indicating that a team effort was involved to make the real estate transaction a success. Suitable information includes the builder's picture and the logo of the builder's company, contact information, links to the builder's web site, and email address, as well as highlights of the builder's abilities and accomplishments. The builder may choose to show pictures of different models and descriptions, or show current developments and neighborhoods. Preferably the administrator rather than the builder controls the content of the web document, so the builder's information preferably is furnished to the administrator for inclusion in the web document. The builder may be required to pay for this exposure, if desired.

Selecting the “Directions” button automatically displays a map, which may be customized and included in the document, or may be displayed via a link to a mapping service such as the MapQuest® service. Directions may be displayed graphically, textually, or both, and may be easily printed. The administration may provide such additional information as is desired.

Selecting the “My Community” button automatically displays information about the community. The “My Community” section is a place to highlight attractions in the community such as golf courses, community centers, parks, schools, shopping areas, museums, and so forth. This information enhances the overall new home experience.

In block 350, the announcement is posted, preferably as a web document. This may be done in any convenient manner, such as by loading the web document onto a web site on one or more servers linked to the Internet. The web site preferably is hosted and maintained by a hosting service, which maintains respective accounts for a number of administrators. The hosting service may be an administrator, if desired. The entire web document may be stored on a single server or distributed among various different servers. The web document may be implemented as a single page, as multiple pages, by the use of frames incorporating documents obtained from the same or different servers, or in any other desired manner.

The administrator preferably is assigned a personal account. Each announcement is given a separate sub-domain name, and each account may administer up to a maximum number of announcements allotted to the account. The administration is also give a professional email template to notify the new homeowners of their announcements, password security for managing the account and for maintaining the announcements, including revising the content, color, music and links in the announcements, and the ability to upload a limited number of photographs per each home presentation (alternatively a size restriction may be imposed). While sub-domains are preferred, announcements may be set up at the domain level or in any other manner desired.

The administrator also has the ability to generate report(s).

When the administrator is an agent, the administrator may run a Tour Report which may include the following: Buyer Client Name, Address, City, State, Zip, Phone, Email, date Presentation created, expiration date and the number of hits or views.

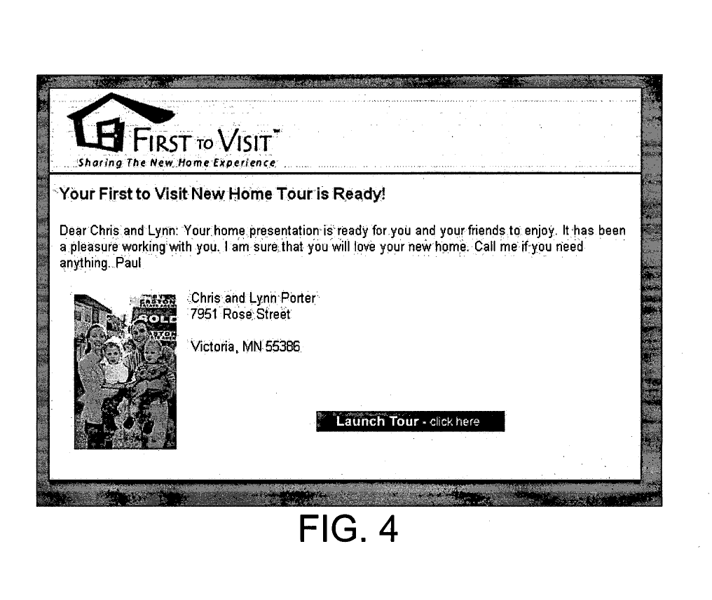

In block 360 the home presentation is “offered” to the new homeowner, preferably as a gift free of charge. The offer may take any desired form, with one particularly suitable form being a tastefully prepared card or email message as shown in FIG. 4, which includes a link to the announcement (“Launch Tour—click here”) and inviting the new homeowner to inspect the home presentation. While the homeowner is likely to inform friends, family and other acquaintances of the availability of the home presentation, preferably the homeowner is put under no obligation to do so.

It may be desired to obtain the homeowners' documented approval of the announcement. This may be done at the time of closing, at the same time as the administrator obtains the testimonial. A suitable form may include a brief description of the announcement and the manner in which it may be used, blanks for writing a testimonial, blanks for furnishing email addresses, and a consent. The brief description may be as follows: “Congratulations on the purchase of your new home! First to Visit™ provides new home owners with an exciting presentation to show off your new home to friends and family while providing them with your new contact information. A First to Visit™ New Home Presentation is an internet based multi-media presentation which includes pictures of you, your new home, your new address, phone number, directions to your new home, info and links about your community, and an interactive guestbook. Please take a minute to fill out the form below.” Next, the new homeowners may be asked to take a moment to write a brief testimonial about their Real Estate Professional and their home buying experience, and to include a sentence or two on what would they would like to say to friends and family about moving into their new home. Finally, the new homeowners may be asked for permission to submit photos, names, address, and other personal/contact information regarding our new home experience in a First to Visit™ New Home Presentation which will be posted on the Internet.

Consent may be obtain in other ways. In one alternative, the real estate agent may present the announcement to the homeowners using a computer at the closing or around the time of closing, and review it with them at that time. The new homeowners are entirely at liberty to approval or object to the announcement. Such approval or objection may be oral or written, as desired.

In another alternative, the announcement may initially be password-secured, and the offer document sent to the new homeowners may include a password to the web document. When the homeowners sign in, they are invited to review the web document in its entirety and indicate their acceptance or objection by appropriate buttons. If the web document is accepted, the document is re-posted as a public web document, without password protection. If the web document is objected to, the administrator is notified and may contact the homeowners to discuss why the web document was objected to.

Since the administrator rather than the hosting service is usually in privity with the new homeowner, the responsibility to obtain the desired approvals should be the administrator's responsibility. To help an agent carry out this responsibility when the agent is the administrator, the agent may be asked when she begins a presentation whether the homeowner has signed a consent form. The agent is allowed to continue with the creation of the presentation if she answers “yes,” but otherwise is not allowed to proceed. The hosting service may, if desired, contractually obligate the administrator to obtain any necessary consents.

As represented by block 400, the homeowner may browse to the web site containing the announcement, display the email form section by selection of the “Email A Friend” button on the home presentation section, enter the addresses of persons whom the homeowner wishes to view the announcement, and select a “Send Emails” button to generate invitations to the prospective viewers containing an invitation to view the announcement and a button for linking to the home presentation. Alternatively or in addition, the new homeowner may send an invitation to herself, and then forward the invitation to others in her personal address book using her own email program.

Preferably all emails originated with the “Email A Friend” button are sent from the same domain hosting the web document. The domain may be carefully selected so as to minimize blockage by spam filters set at medium or low filtering levels. If the homeowner is aware that a particular intended viewer has implemented strong spam filtering, the buyer may send the invitation directly from her own email program, or may send an email messaging informing the intended viewer that an email of interest will be sent from a particular domain and inviting the intended viewer to add that domain to the exceptions list of the spam filter.

As represented by block 410, each emailed invitation preferably contains subject header information identifying the new homeowner, so that the prospective viewer can recognize the buyer and opt to read the invitation.

As represented by block 420, the prospective viewer may ignore the invitation, read the invitation but decline to view the announcement, or select the link to view the announcement. In the unlikely event that the recipient ignores the invitation or reads the invitation but declines to view the announcement (block 420-NO), the prospective viewer moves on to other activities (block 500) and the referral opportunity is lost to the transaction participants. In the much more likely event that the prospective viewer is interested in viewing the announcement, the prospective viewer selects the link (block 420-YES) and the prospective viewer's browser loads the home presentation portion of the web document so that the recipient may enjoy the home presentation and read the new homeowners' testimonial (block 430).

Once the home presentation and testimonial are concluded, the viewer preferably is presented with a option to continue, such as by selecting a “NEXT” control, or may select one of the topical buttons displayed with the home presentation. Preferably the “NEXT” control is a link to the administrator's information—if the administrator is the real estate agent, the “NEXT” control acts just like the “My Real Estate Agent” button.

Alternatively, the viewer may choose to investigate other areas of the announcement by selecting the various buttons as desired. As shown in FIG. 3, the viewer may choose to sign the guest book (block 440-YES and block 450) or may decline to do so (block 440-NO), may choose to view information on the transaction participants and related information (block 460-YES and block 470) or may decline to do so (block 460-NO), and may choose to send email invitations to others to view the announcement (block 480-YES and block 490) or may decline to do so (block 480-NO). The availability of these actions may be suggested by the presence of various topical buttons such as “My Real Estate Agent,” “My Lender,” “My Builder,” “Directions,” and “My Community.” Alternatively, the viewer may be led through a series of pages that guide the viewer into view further information on various topics of interested, and including respective buttons for doing so.

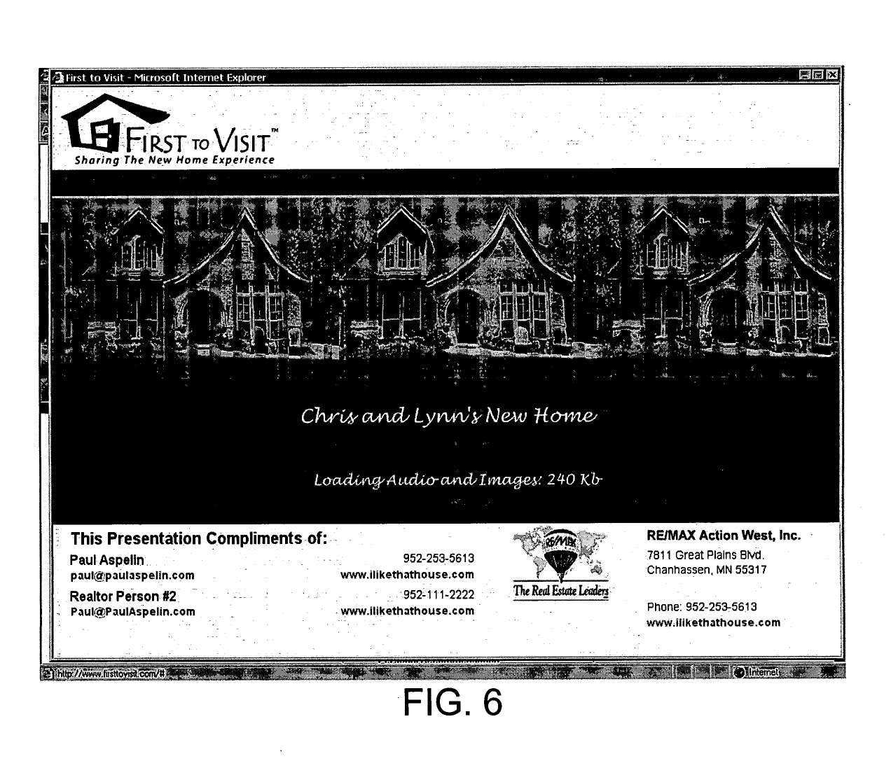

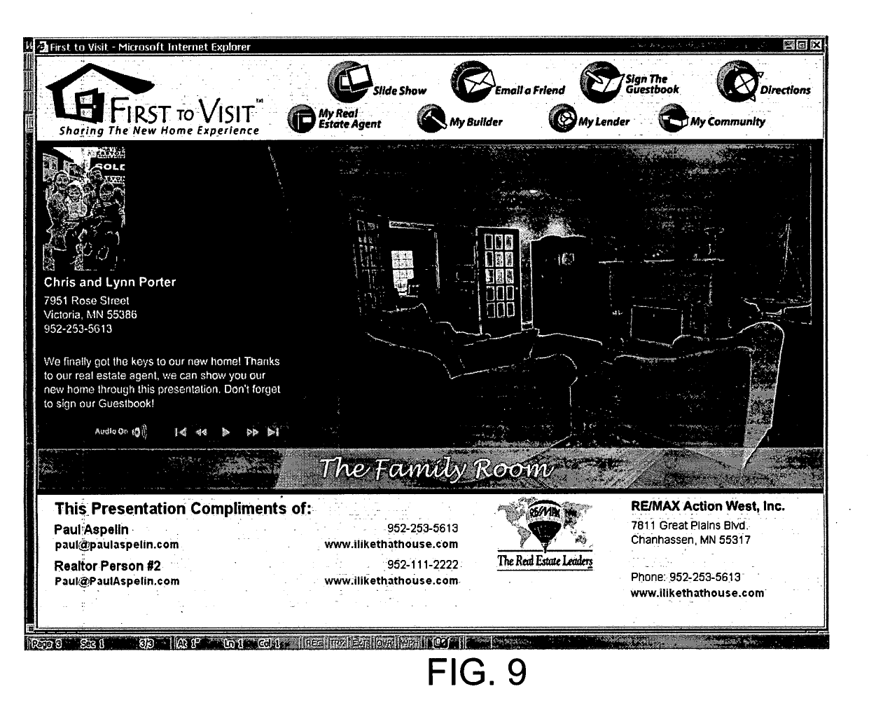

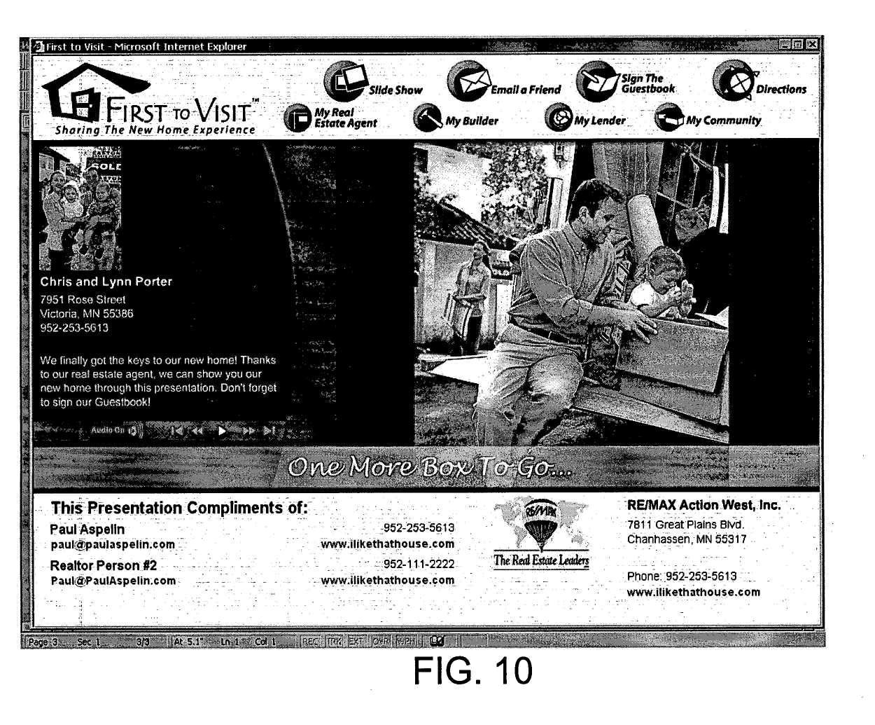

FIGS. 6-21 are images of an announcement as it progresses through various views both automatically and by interactive activity of a viewer. FIG. 6 is a screen that loads quickly and provides and attractive montage of thumbnails of the pictures to be displayed in the home presentation slide shown. The screen of FIG. 6 remains on the browser until the slide show loads.

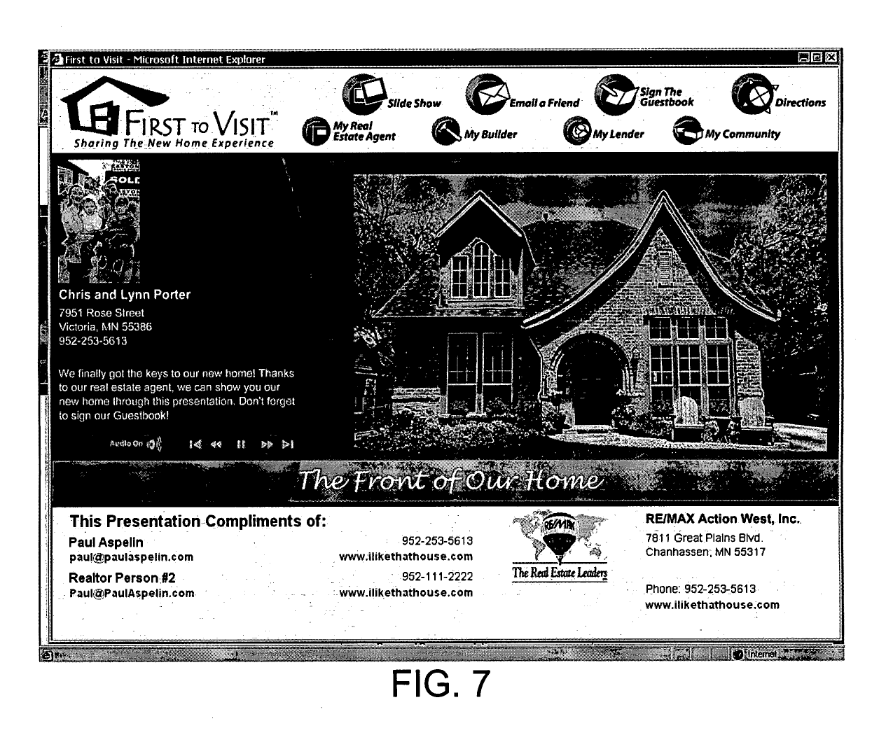

FIG. 7 is the first screen of the slide shown. Across the broad middle of the screen from left to right are the new homeowner area and the new home presentation area. Across the top from left to right are the name and logo of the hosting service, and the various topical buttons for obtaining more information about the transaction participants. Across the bottom is an area for the administrator to display any desired information, or none at all. In the example of FIGS. 6-21, the administrator is the real estate agent, and he has chosen to identify himself and provide company affiliation and contact information.

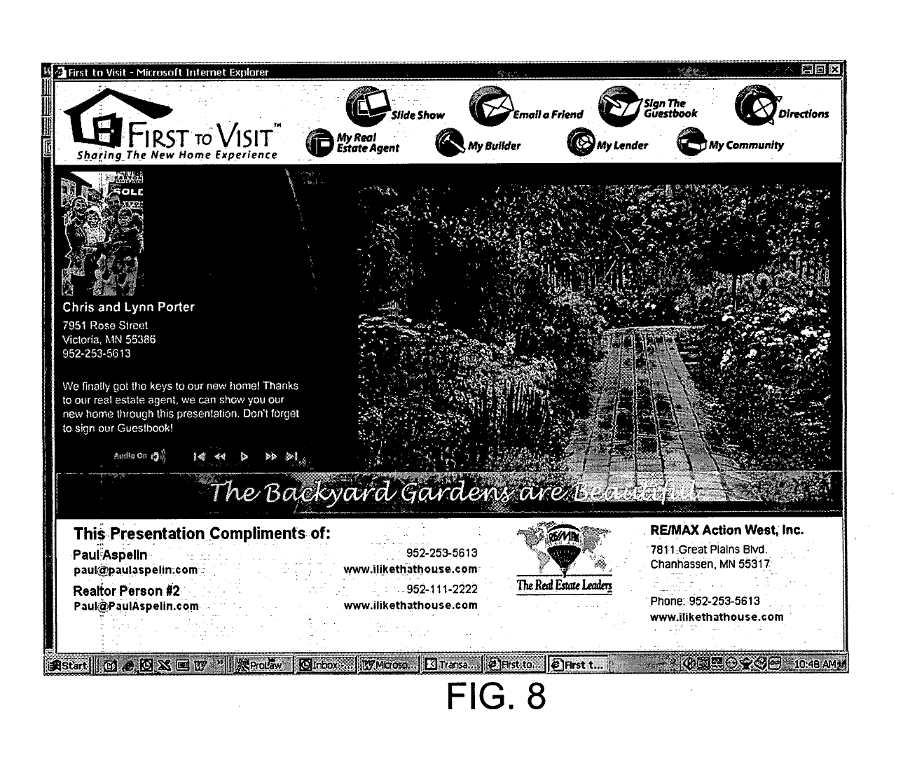

FIGS. 8-10 are screens that appear as the slide show progresses. Additional pictures of the home and homeowners are shown, while the basic homeowner information, hosting service information, topical buttons, and administrator information remain the same.

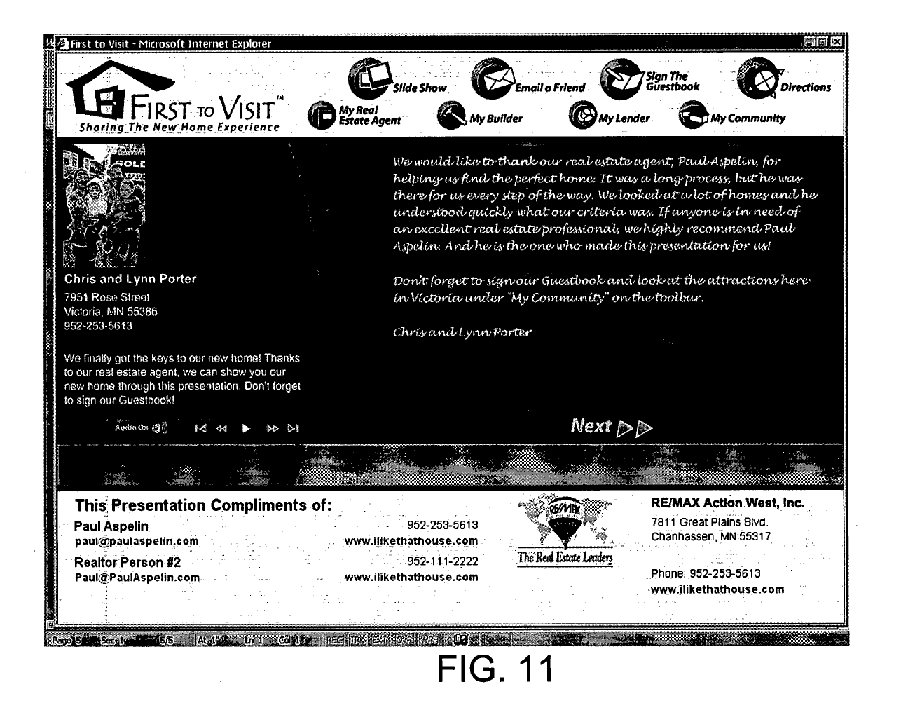

FIG. 11 shows the last slide of the home presentation, which is the homeowner's testimonial. A “Next>” control is displayed. The viewer may select the “Next>>” control, or any of the topical buttons.

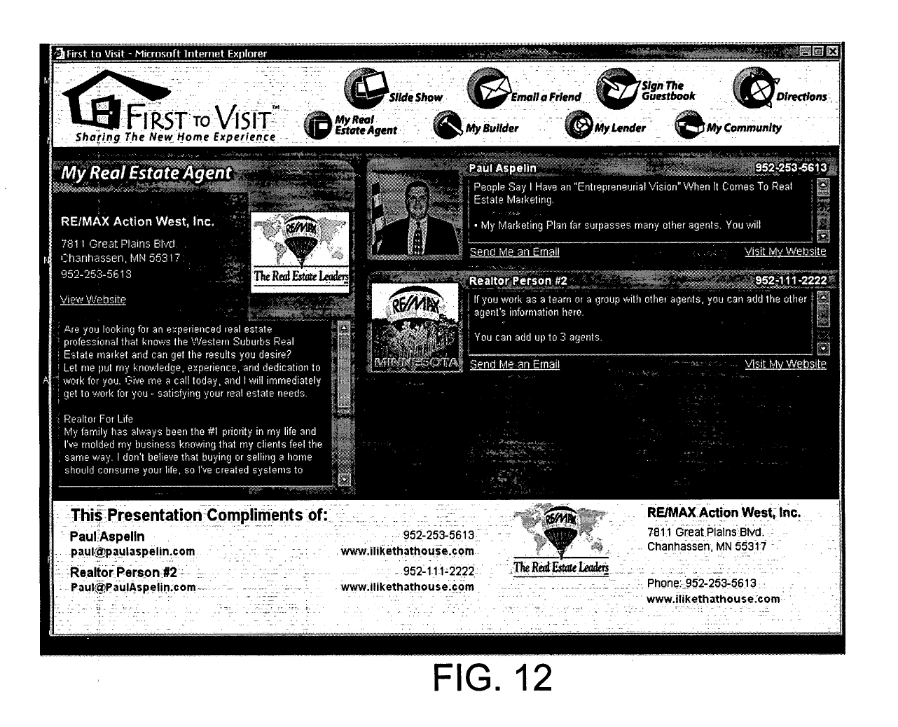

FIG. 12 results from selection of the “Next>>” control. While any desired action may be programmed, illustratively selection of the “Next>>” control displays real estate agent information across the broad middle of the screen. The hosting service information and topical buttons across the top, and the administrator information across the bottom remain the same.

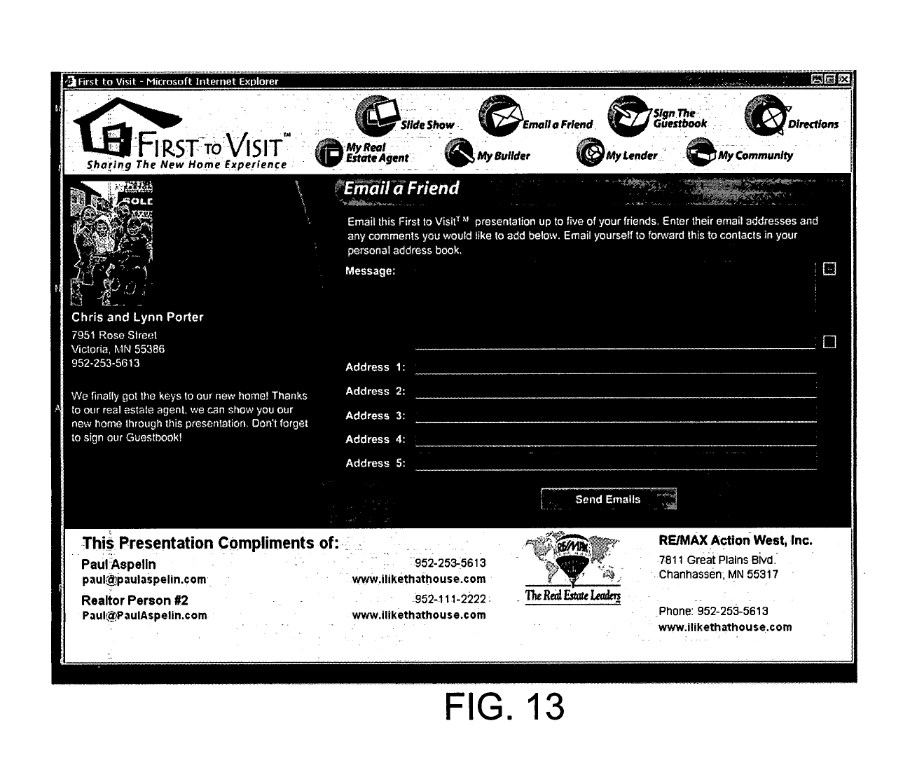

FIG. 13 results from selection of the “Email a Friend” button. The screen is a form for entering email addresses to which invitations are sent when the “Send Emails” control is selected. The hosting service information and topical buttons across the top, and the administrator information across the bottom remain the same.

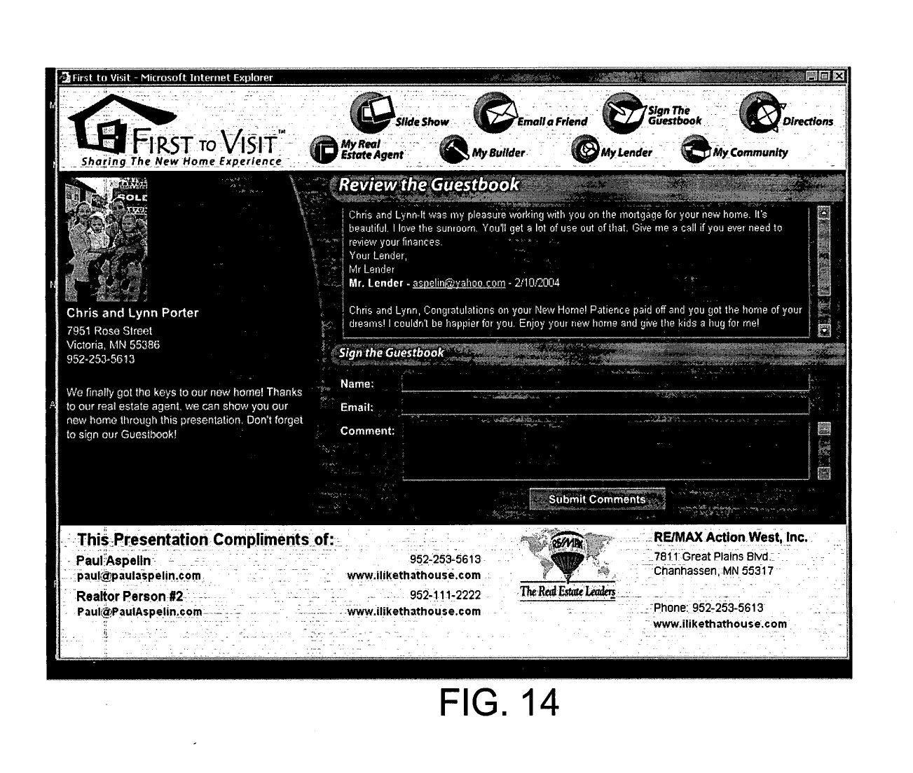

FIG. 14 results from selection of the “Sign the Guest Book” button. The screen is a form for entering a name, email address, and a comment. The comments are submitted by selecting the “Submit Comments” control, which causes them to be entered into the Guest Book. The various comments may be reviewed by scrolling through the text in the window “Review the Guestbook.” The hosting service information and topical buttons across the top, and the administrator information across the bottom remain the same.

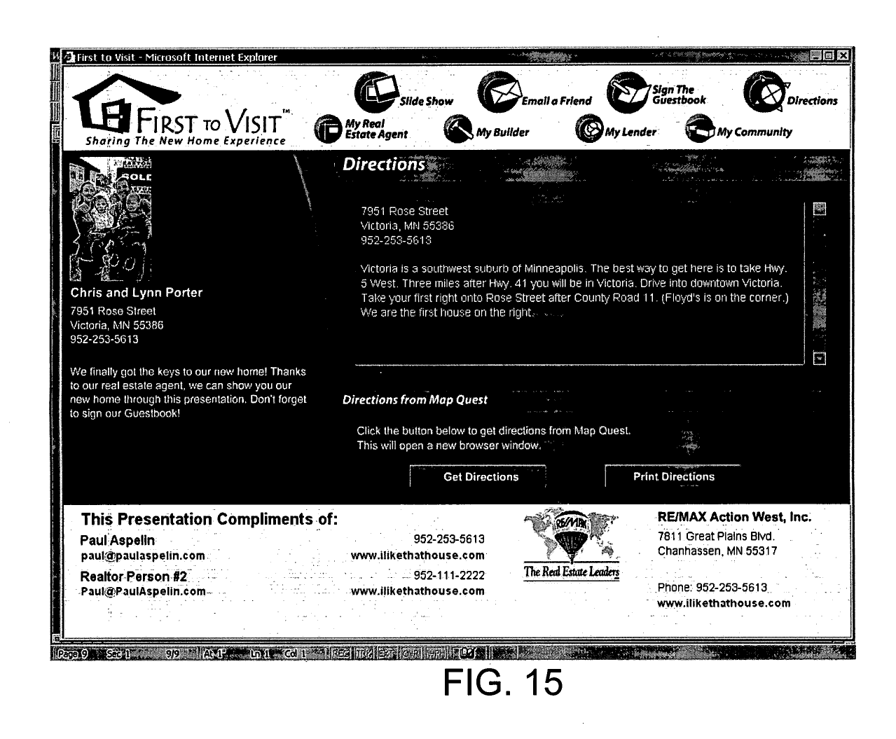

FIG. 15 results from selection of the “Directions” button. The screen displays direction information across the broad middle. The hosting service information and topical buttons across the top, and the administrator information across the bottom remain the same.

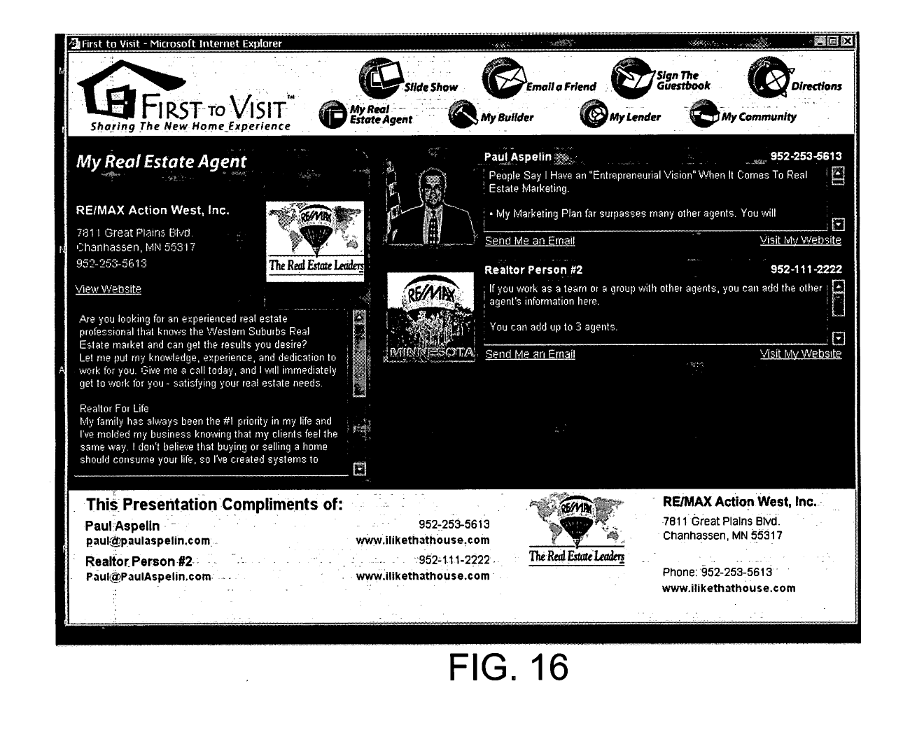

FIG. 16 results from selection of the “My Real Estate Agent” button. The screen displays real estate agent information across the broad middle. The hosting service information and topical buttons across the top, and the administrator information across the bottom remain the same.

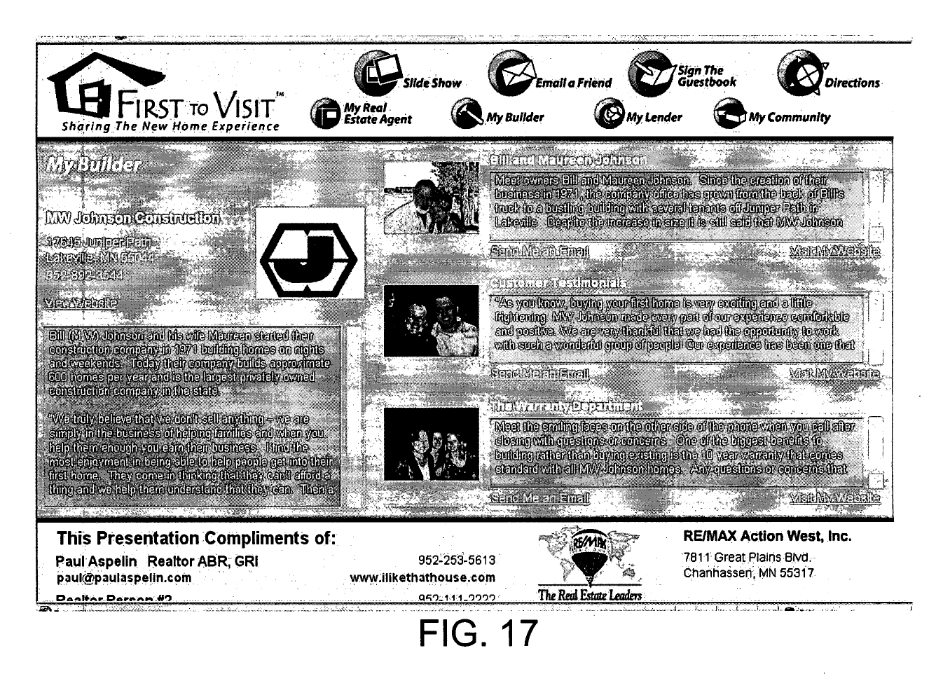

FIG. 17 results from selection of the “My Builder” button. The screen displays builder information across the broad middle. The hosting service information and topical buttons across the top, and the administrator information across the bottom remain the same.

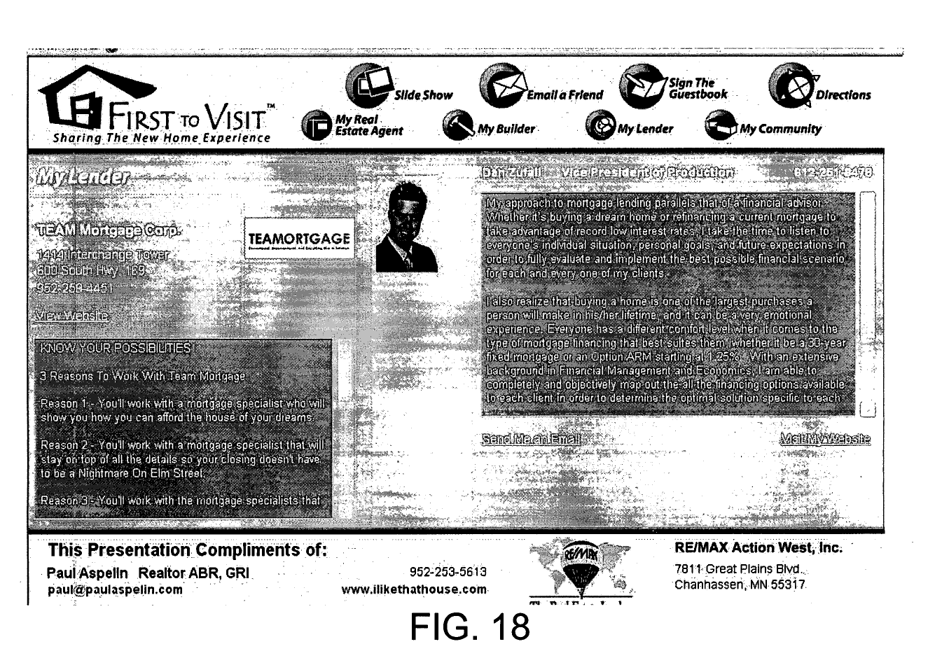

FIG. 18 results from selection of the “My Lender” button. The screen displays lender information across the broad middle. The hosting service information and topical buttons across the top, and the administrator information across the bottom remain the same.

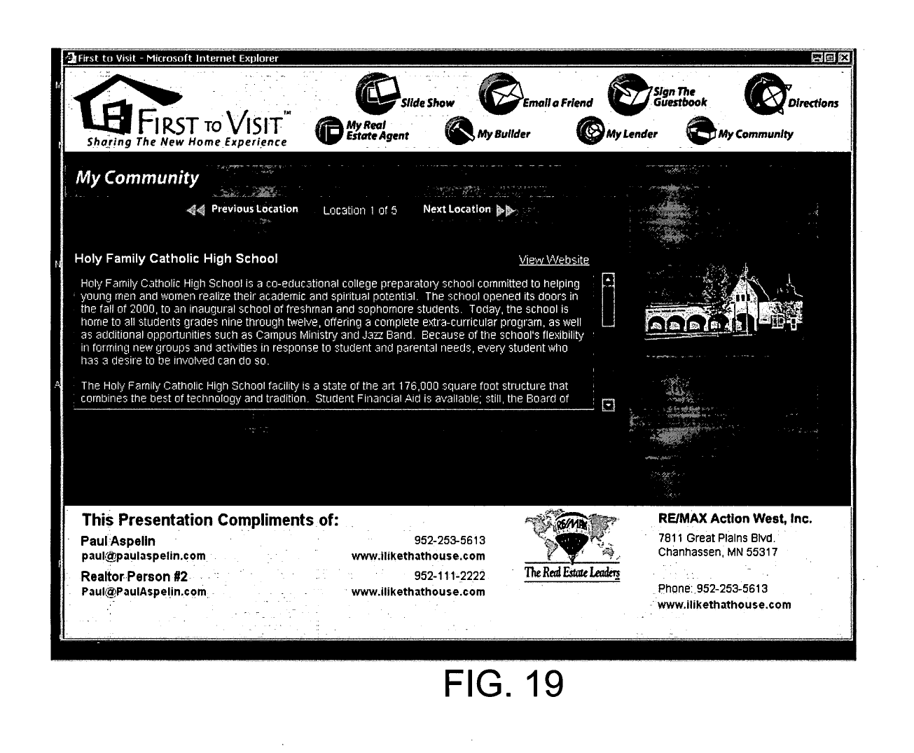

FIG. 19 results from selection of the “My Community” button. The screen displays community information across the broad middle. The hosting service information and topical buttons across the top, and the administrator information across the bottom remain the same.

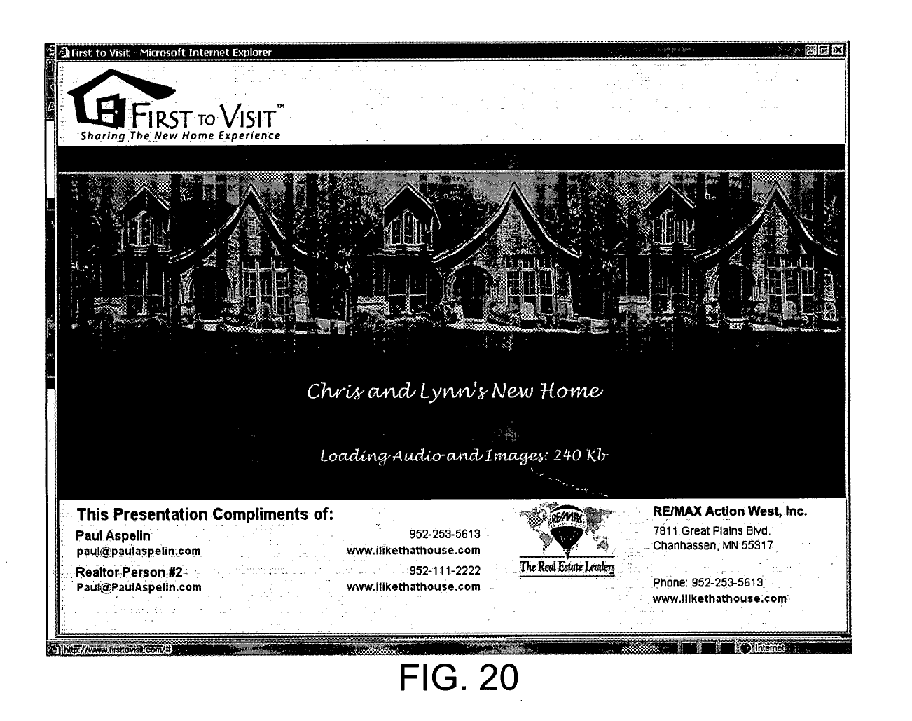

FIG. 20 results from selection of the “Slide Show” button. As is so for the screen of FIG. 6, this screen displays quickly and remains visible while the slide shown is loading.

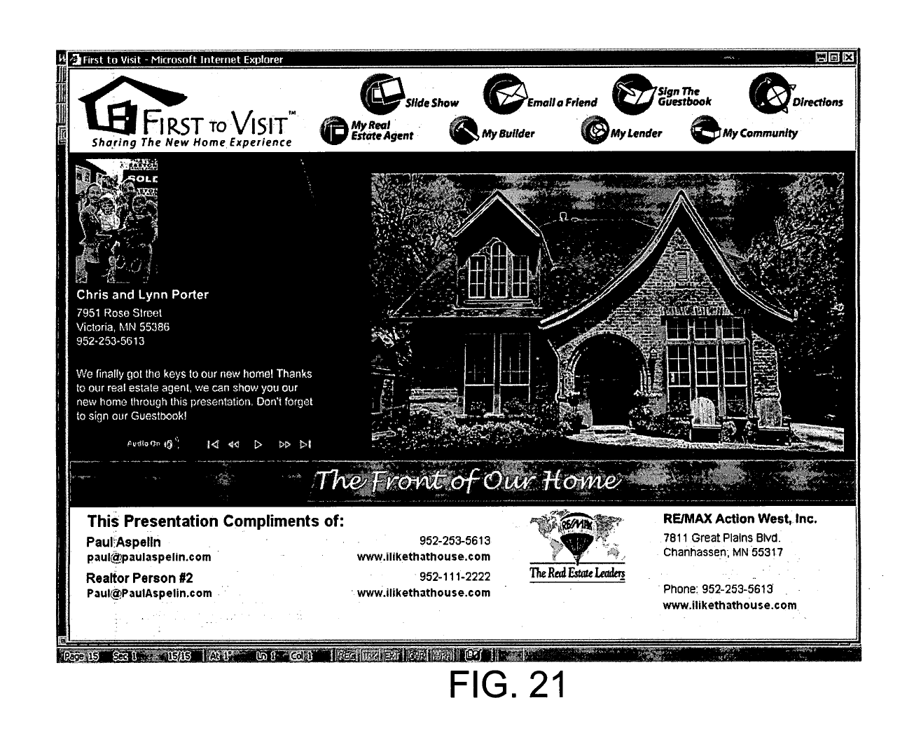

FIG. 21 displays after the slide show has loaded, and is the same screen as shown in FIG. 7.

Administrators may be sent the following text in one or more emails once they are account holders.

Email for lenders: Obligation and reciprocation. If you do something that people find value in, they will feel obligated to reciprocate the favor. Lenders . . . if you approach a realtor and offer to pay for all or part of a presentation or subscription, they will feel that you have given them something of value, and will surely sign up for the service. Every time they do a First To Visit (“FTV”) website they will think of you and the great job you did for them. And will feel obligated to give you at least one more deal, and at the least they will use you again when the FTV website generates a referral. Besides that, the realtor will be astonished that you have a marketing tool that you say has worked for them before and will jump all over the idea. Just tell them that you have an idea that you have used with several other Realtors that you found very effective. You ask nothing in return. They won't believe what they are hearing.

Once you get the FTV website up and running, Enter the guest book and put your own comments in there. IE: Chad and Sue were some of the nicest clients I have ever worked with. It is truly a joy to work with people that are so much fun. This gives you another chance to tell the people who visit the FTV website that you like their friends as much as they do. Very powerful: Even more powerful if you can really personalize it to include something about them that makes people realize that you do know them well. IE: Shelly and Bryon got the third stall because they need room for the Corvette Bryon will be getting shortly. Or Now Bryon has a place to finally store all those model cars.

Email everyone involved in the transaction and have them post a message in the guest book. Your Lender, the closer, the inspector, the appraiser, the underwriter, the loan processor, the builder. This gives a huge “wow” factor to your clients that everyone had their best interest first and foremost in their minds. Your clients won't believe all the people involved with the transaction, let alone believe that they would take the time to congratulate them. The people they send it too will feel like your clients are part of a special group or club, and feeling a part of something so special is a powerful motivator. People want to feel included. And don't want to be missing out. This also gives the impression that their friends hired a team of professionals to assist them not just one person.

Have the broker /owner of your company sign the guest book. This is extremely powerful because it shows potential clients that no one is too big or busy to take the time to thank them for choosing their company.

Once people get settled into their new home with their belongings, offer to come over again and re-take photos of their home with their things in it. Across the top of the web page write. WE'RE FINALLY SETTLED. Your clients will then email it out a second time to show off how their things fit into the new house.

Every time you are searching for new business, send out the webpage and ask your clients to forward to anyone they know who might be moving. Maybe at the one year mark. With a congratulations on being in your new home a year.

Change the website around so that people can email it out as an invitation to a house warming party. Or at least a reminder.

If your clients send you a referral, ask them if you can email the referral a copy of their webpage to solidify things.

How many of you work with a lender that hands your cards out to many people each year. Now your lender has the opportunity to email and follow up with these people by sending them a FTV website of a former happy client. The power of the testimonial is just awesome. People will read the guest book with comments from all those involved as well as those who were friends and just posted a congratulations. People will want to have the same experience as the happy clients. By having your lender show people the FTV site, it will give you the edge you need. Buyers will look at the card of the other Realtor and say . . . this person isn't nearly as cutting edge, dynamic, trustworthy, as the guy with the FTV website.

Sometimes clients who are on the fence need an extra shove or just extra reassurance that things will be ok. By showing a prospect the end result for someone else, it will motivate them to move forward as well. Look how exciting their transaction was!!!!! It sends a subliminal message of a successful transaction.

By giving a FTV website, it's almost like throwing a party for your clients. The interaction the buyers will receive from the guest book will make them experience a part of the transaction that other Realtors don't offer. That is that you truly care about them after the closing and want to help them share their good fortune with others.

The FTV website relies on referral Marketing methods (Word of mouth) to advertise your successful transaction. Most Realtors market their services, we market your success.

People have a natural tendency to share things they have never seen before with friends. People will forward the FTV site to people simply saying “Look what Chad and Sue got from their Realtor” it is so cool. The Will forward it to people just because it's cool.

People are gabby, and they are always sharing info about others at the water cooler. Did you hear that Chad and Sue bought a new house? I will send you the link, it's awesome.

Many people get the “Bug” to buy a new house when someone they know buys one. Why not put the bug in hundreds of people and the result will be referrals.

You can also use the FTV site to work Expireds and For Sale By Owner (“FSBO's”). Send them an email with a link to a satisfied customer. Or send them to your website to see a link. You could send them a note simply saying check out my website for happy customers. The curiosity will get to them and they will go there, because you haven't started the relationship off by trying to sell them something. You simply want them to see the great job you have done.

Rather than posting bland testimonials on your website, post a FTV presentation. This will give prospects a great idea of what you are all about as well as showcase the various people you have had the opportunity to work with. A picture speaks a thousand words. Imagine what a presentation of a happy client can do.

Every time you meet with a buyer, send them a links to a FTV presentation before you meet to showcase the happy people you have served. Very Powerful.

Send an FTV website to all those in your sphere of influence every time you get a happy client. People may not know these people, but it will put the thought in their head that you are creating happy clients and showing off your success is not arrogant, its good business. People will think of you when someone mentions the need for a Realtor.

How many times have you run into some one who is a part of your sphere group, and the first thing out of their mouth is “How's business” if you send them FTV sites periodically, they will know. If you have anyone that I can make as happy as Chad and Sue, please let me know.

Use it to market listings. Send an FTV website to prospects who have come to an open house, asking for feedback in the Guest book.

Getting true feedback from people who enter the open house has always been a challenge. Send those who sign up the website and ask for their feedback in the guest book.

Ask other agents for feedback in the guestbook as well. It is a great way to keep your sellers informed.

Paste a link for your FTV site in the signature of your emails. Every time your email goes out, people will have the opportunity to see what your are offering.

The description of the invention and its applications as set forth herein is illustrative and is not intended to limit the scope of the invention. Variations and modifications of the embodiments disclosed herein are possible, and practical alternatives to and equivalents of the various elements of the embodiments would be understood to those of ordinary skill in the art upon study of this patent document. For example, where methods are described herein, systems, transmission medium, storage medium, software, apparatus, general purpose computer, and other implementations of the methods would be understood. These and other variations and modifications of the embodiments disclosed herein may be made without departing from the scope and spirit of the invention.

1. A method of obtaining, over the Internet, consensual referrals arising from a transaction involving real estate, at least one party having an relationship to the real estate as a result of the transaction, and at least one party being a participant in the transaction, comprising:
presenting to a first viewer a first email invitation to view the announcement, the announcement being a web document comprising information on the related party and a presentation comprising pictures of the real estate and a testimonial;
furnishing the related party information and the presentation to a browser of the first viewer, in response to a request from the first viewer;
presenting a control on the browser of the first viewer for receiving information on the transaction participant;
presenting a form on the browser of the first viewer for entering an email address for a second viewer;
presenting to the second viewer a second email invitation to view the announcement, in accordance with the second viewer email address;
furnishing the related party information and the presentation to a browser of the second viewer, in response to a request from the second viewer;
presenting a control on the browser of the second viewer for receiving information on the transaction participant; and
presenting a form on the browser of the first viewer for entering an email address for a second viewer.

2. The method of claim 1 further comprising furnishing a guest book to the browser of the first viewer, in response to a request from the first viewer.
